(19) United States
(12) Patent Application Publication
(10) Pub. No.: US 2011/0240156 A1
(43) Pub. Date: Oct. 6, 2011

(54) Double Block and Bleed Sandwich-Type Valve

(76) Inventor: Lounis Azibi, Liege (BE)

(21) Appl. No.: 12/752,698

(22) Filed: Apr. 1, 2010

(51) Int. Cl. F16K 1/44; F16K 25/00

(52) U.S. Cl. 137/613; 137/628

(57) ABSTRACT

An improved sandwich-type valve made according to this invention has two seals that move and seal independent of one another. The first seal is located on the upper surface of the valve member or disc and moves with the valve disc toward and away from the upper plate in response to fluid pressure. The second seal is a floating seal that is received by a seat of the lower plate portion of the valve body. The second seal moves toward and away from the lower plate in response to fluid pressure. A bleed port may be provided in the spacer flange between the first and second seal.

### FIELD OF THE INVENTION

This invention relates generally to sandwich-type valves used to prevent flow through a pipeline or access connection to a pipeline during hot tapping and plugging operations. More particularly, the invention relates to an improved arrangement of providing double block sealing between the valve member or disc and the valve body.

### BACKGROUND OF THE INVENTION

“Double block and bleed” is a well-known term of art in the pipeline and piping industry that refers to setting two seals in a pipe and opening a bleed port between the seals to ensure that the first seal is holding. Any leakage past the first seal is contained by the second seal and forced to exit through the bleed port. This arrangement also prevents any unwanted buildup of pressure occurs across the second seal and ensures that the pipe is completely sealed.

Sandwich-type valves are typically employed in hot tapping operations. In the typical hot tapping operation, a fitting—usually in the form of a flange—is welded on the exterior of a pipe that has flowing gas or liquid under pressure. A sandwich-type valve is then secured to the flange and a hot tapping machine is secured above the valve. A valve member or disc moves laterally between a closed seated position across the passageway provided by the fitting and an open unseated position free of the passageway. By use of specialized equipment, when the valve disc is in its unseated position, a boring bar with a cutter tool attached may pass through the valve body and cut a hole through the wall of the pipe while gas or liquid continues to flow through it. This hole provides access to the interior of the pipe, such as for inserting equipment to temporary block flow through the pipe while repairs are being made. The valve disc is opened whenever equipment must pass through the valve body and is closed whenever necessary. After repairs are complete, a threaded or non-threaded completion plug is typically inserted as a temporary seal below the sandwich valve so that any equipment secured above the valve may be reclaimed.

Prior-art sandwich-type valves are similar to the one disclosed in U.S. Pat. No. 3,047,226, titled “Valve” and issued to B. Ver Nooy on Jul. 31, 1962. The valve member or disc is contained within the open space of a spacer ring or flange that is secured between two plates. The valve disc is provided with O-ring type seals on its lower and upper face portion and a retainer ring on each face facilitates placement of the O-ring and provides fluid pressure to the groove in which the O-ring is located. When the valve is in its seated position across the ports of the plates, the seals provide sealing engagement with the face surfaces or seats of the plates and prevent fluid flow between the ports. However, fluid pressure above or below the valve disc pushes the valve disc away from one of the seats and toward the other seat. Although this design provides adequate and proper sealing, the dependent arrangement of the seals may create a potential leak path through the seal that is being pushed away from its seat.

An object of this invention is to provide an improved sandwich-type valve in which the movement of one seal does not affect the sealing performance of the second seal. Another object of this invention is to provide a sealing arrangement that energizes substantially instantaneously at low pressure and seals at high pressure. Yet another object of this invention is to provide a sandwich-type that may be applied in surface and subsurface (on-shore and offshore) hot tapping and plugging applications. Still yet another object of this invention is to provide seals that may be re-energized, lubricated, or substantially backed-up in case of an in-service leak. A still further object of this invention is to provide a sandwich-type valve that allows existing valves to be easily retrofitted with the improved features of the valve. Last, an object of this invention is to provide for bleed capability between the seals of the valve.

### BRIEF SUMMARY OF THE INVENTION

An improved sandwich-type valve made according to this invention has a substantially flat valve disc located in an open space of a spacer flange. The valve disc is moveable in the open space between an unseated position and a seated position. When in the seated position, the valve disc is disposed across ports located above and below the spacer flange in an upper and lower plate, respectively, and blocks flow between the ports. Sealing engagement is provided by a first and second seal. The two seals move and seal independent of one another.

The first seal is located on the upper surface of the valve disc and is preferably an O-ring type seal. The first seal moves with the valve disc toward and away from the upper plate in response to fluid pressure. This seal provides sealing engagement with the lower face surface or seat of the upper plate.

The second seal is a floating seal that is received by a seat of the lower plate. The second seal moves toward and away from the lower plate in response to fluid pressure and provides sealing engagement with the lower surface of the valve disc and the seat of the lower plate. This movement is independent of that of the first seal and the valve disc. A spring may be provided to bias the second seal in its top position, that is, moving away from the lower plate and toward the valve disc. Means may also be provided to limit the vertical movement of the second seal. The second seal is preferably a double O-ring type seal, with the first O-ring type seal being located on an upper surface of the second seal and the second O-ring type seal being located about a peripheral side surface of the second seal.

Both the first and second seals are capable of providing “bubble tight” sealing performance at low and high pressure. Preferably, the second seal moves away from the lower plate and upward toward the valve disc substantially instantaneously as fluid pressure rises above 0 bars. The first and second seals may be configured so that the fluid pressure that the first seal responds to is a different fluid pressure than what the second seal response to.

A bleed port may be provided in the spacer flange between the first and second seal. The bleed port provides an extra measure of safety and is preferably capable of handling whatever fluid (or gas) escapes past the second seal to ensure that no unwanted buildup of pressure occurs across the first seal.

### BRIEF DESCRIPTION OF THE DRAWINGS

FIG. 1 is cross-section view of a preferred embodiment of an improved sandwich-type valve made according to this invention. The valve moves laterally between an unseated and seated position to block fluid flow between ports located above and below the valve disc (see also FIGS. 8 & 11). Here the valve is shown in its closed or seated and sealed position. Two independent seals, which are capable of sealing at both low and high pressures, provide double block sealing performance and prevent fluid flow through the ports of the valve body. Should either seal fail, the other seal continues to prevent fluid flow between the ports.

FIG. 2 is a top plan view of the valve of FIG. 1. The valve disc is made of a resilient material and is of such a size that when it is in the seated position, it is disposed across the ports to prevent flow between the ports.

FIG. 3 is an isometric view of the valve of FIG. 1 when secured to a pipeline flange in a typical hot tapping operation.

FIG. 4 is a view of the valve of FIG. 1 taken along section line 4-4 of FIG. 1. The first seal moves with the valve disc in response to fluid pressure. The second seal is a floating seal which moves independent of the first seal in response to fluid pressure.

FIG. 5 is an enlarged view of detail 5 of FIG. 1, illustrating the sealed connection between the valve stem and the valve body. Turning the handle moves the valve disc into and out of register with ports (see FIGS. 3, 8 & 11). The sealed connection permits the valve stem to rotate without leakage but prevents the valve stem from moving longitudinally.

FIG. 6 is an enlarged view of detail 6 of FIG. 1. A passageway is provided for internal bypass of the closed valve. When the threaded valve is in its closed position, bypass is prevented. When in the open position (see FIG. 7), bypass is permitted.

FIG. 7 is a view of the threaded valve of FIG. 6 shown in the open position. A pin prevents the valve from backing out too far and venting to atmosphere.

FIG. 8 is cross section view of the valve of FIG. 1 showing the valve in its unseated or opened position.

FIG. 9 is a view of the valve of FIG. 1 taken along section line 9-9 of FIG. 1. A plug is provided at the upper end of the bypass passageway.

FIG. 10 is a view of the valve of FIG. 1 configured for external bypass.

FIG. 11 is a view of the valve of FIG. 1 with the upper plate removed and showing the valve in its open or unseated position.

FIG. 12 is a view of the valve of FIG. 1 configured with a bleed port located between the double block seals.

FIG. 13 is a view of the valve taken along section line 13-13 of FIG. 12. Means are provided to limit the vertical movement of the second seal. A spring may be used to bias the second seal in its top position.

### DETAILED DESCRIPTION OF THE PREFERRED EMBODIMENTS

Preferred embodiments of an improved double block and bleed sandwich-type valve will now be described by making reference to the drawings and the following elements illustrated in the drawings:

The elements listed in the drawings are as follows:

| | |
|---|---|
| 10 | Improved sandwich-type valve |
| 11 | Valve body |
| 12 | Bypass passageway |
| 13 | Studs |
| 15 | Valve stem |
| 17 | Sealed connection |
| 19 | Handle |
| 20 | Upper plate |
| 21 | Face surface/seat |
| 23 | Port |
| 25 | Lateral passageway portion of 12 |
| 27 | Plug |
| 30 | Center spacer ring/flange |
| 31 | Open space |
| 33 | O-ring type seal |
| 35 | Passageway |
| 37 | Bleed valve |
| 40 | Lower plate |
| 41 | Face surface/seat |
| 43 | Port |
| 45 | Face surface/seat |
| 47 | Upper end of 40 |
| 49 | Wall surface of 45 |
| 51 | Groove in 40 |
| 59 | Lateral passageway portion of 12 |
| 61 | Threaded valve |
| 63 | Pin |
| 70 | Valve disc |
| 71 | Annular groove |
| 73 | Upper surface of 70 |
| 75 | Segmented ring |
| 77 | Lower surface of 70 |
| 79 | Dovetail portion of 71 |
| 80 | First seal |
| 90 | Second seal (assembly) |
| 91 | O-ring type seal |
| 93 | Annular groove |
| 95 | Upper end of 107 |
| 97 | O-ring type seal |
| 99 | Annular groove |
| 101 | Peripheral surface of 107 |
| 103 | Tab |
| 105 | Spring |
| 107 | Ring |
| 111 | Piping |
| 113 | Valve |

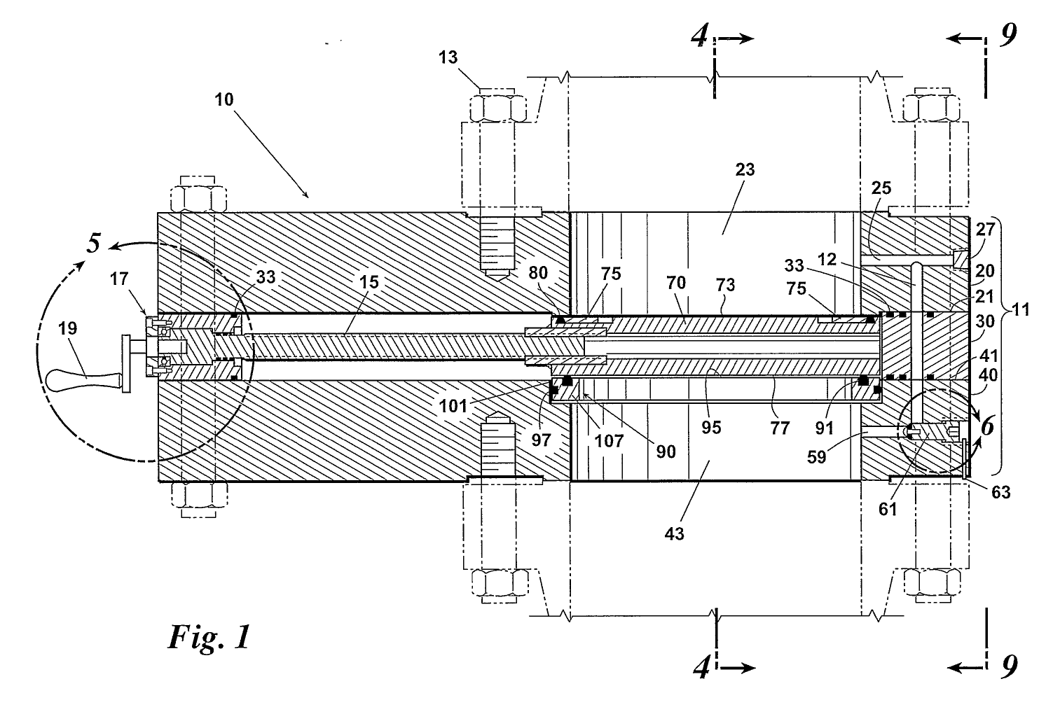

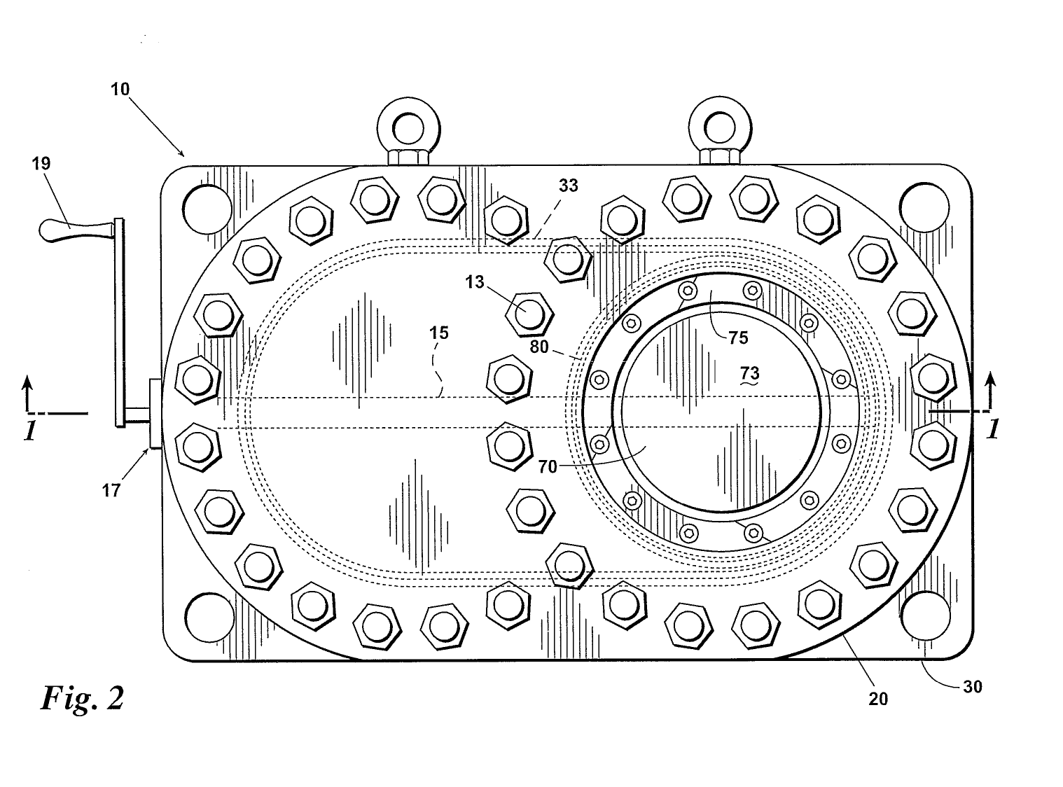

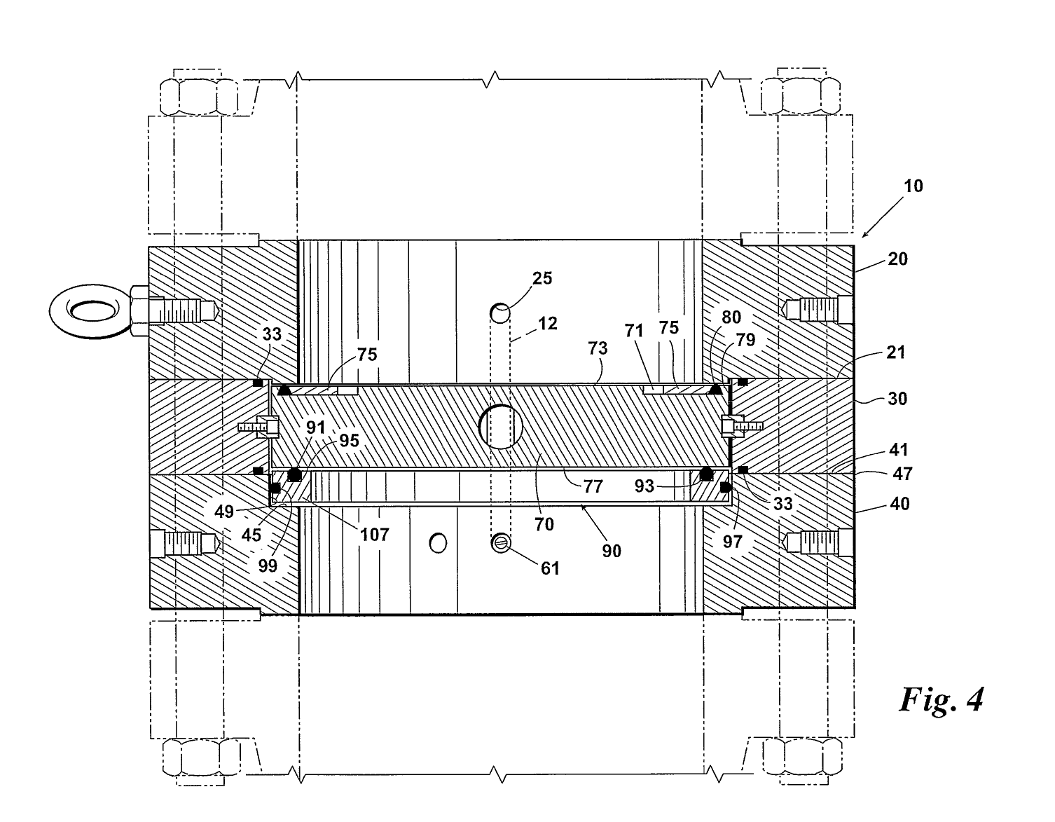

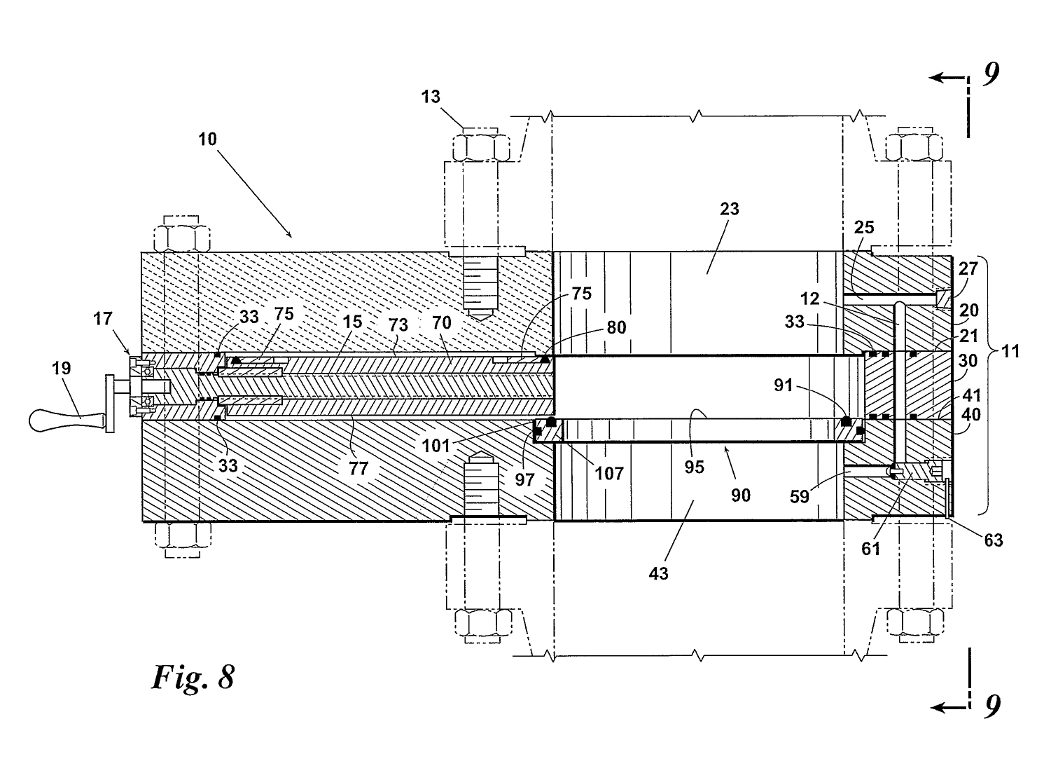

Referring first to FIGS. 1-4 & 8, an improved sandwich-type valve 10 includes an upper and lower plate 20, 40, each with a preferably substantially flat face surface 21, 41 and a port 23, 63. Surfaces 21, 41 and the surrounding ports 23, 43 are referred to as “seats.” Sandwiched between the plates 20, 40 is a center spacer ring or flange 30 which has an open space 31 in which a closure or valve disc 70 is disposed (see also FIG. 11). Valve disc 70 moves laterally within an open space 31 between an unseated position (see FIGS. 8 & 11) and a seated position (see FIGS. 2 & 3). Plates 20, 40 and flange 30 collectively form the body 11 of valve 10 and are held together by a plurality of studs 13 and sealed by O-rings 33 disposed on opposite sides of flange 30. Open space 31 and the ports 23, 43 form a fluid flow passageway through valve body 11.

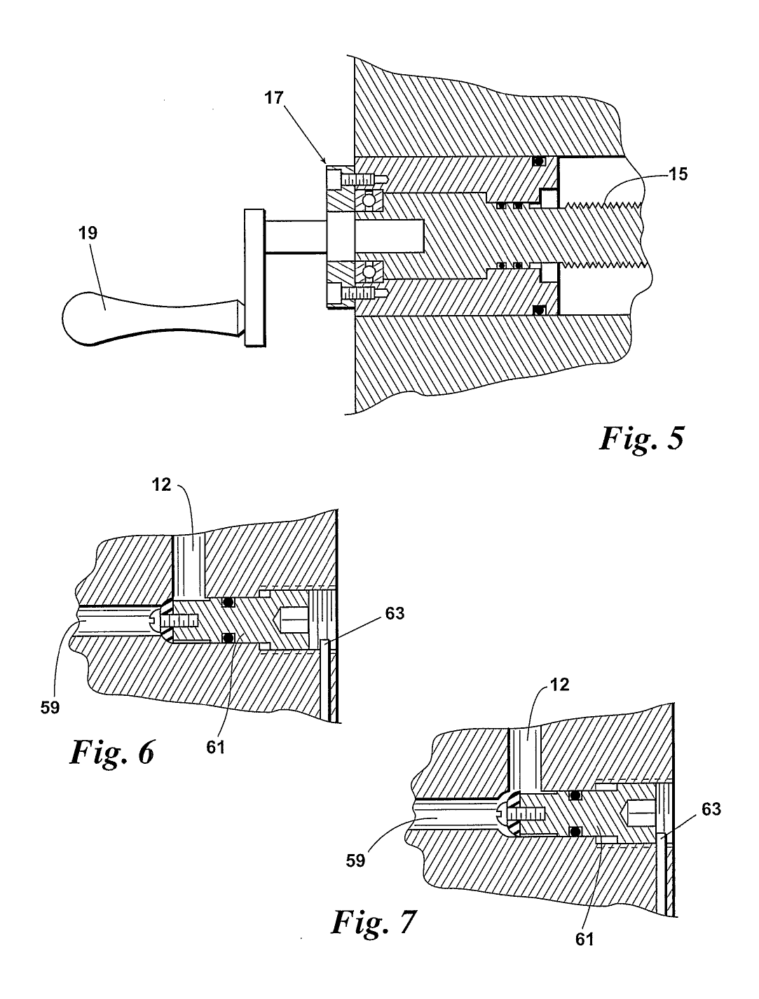

Valve disc 70 is of such a size that when it is in the seated position, it is disposed across the ports 23, 43 to prevent flow between the ports 23, 43. Valve disc 70 may be moved laterally between its seated and unseated positions by any suitable means, including hydraulic means (not shown). Manual means may include a valve stem 15 in communication with valve disc 70 and having a sealed connection 17 with flange 30 (see FIG. 5). Sealed connection 17 permits valve stem 15 to rotate without leakage but prevents the valve stem 15 from moving longitudinally. Turning the handle 19 moves valve disc 70 into and out of register with ports 23, 43.

To provide double block sealing, a first and second seal 80, 90 is employed. Should either seal 80, 90 fail, the other seal 90, 80 continues to prevent fluid flow between the ports 23, 43. The seals 80, 90 preferably have both low and high pressure sealing capability, with the seals 80, 90 being “bubble tight” at near zero pressure as well as at maximum allowable operating pressures (e.g., 900 psi, 1500 psi). The seals 80, 90 may be re-energized, lubricated, or substantially backed-up in case on an in-service leak without permanent loss of seal integrity.

The first seal 80 is preferably an O-ring type seal disposed in an annular groove 71 located on the upper surface 73 of closure disc 70. A segmented ring 75 facilitates placement of seal 80 into groove 71 and provides for pressure fluid to flow into a dovetail portion 79 of the groove 71. Seal 80 moves vertically upward (or downward) with valve disc 70 and, therefore, toward (or away from) seat 21 in response to fluid pressure. Seal 80 provides sealing engagement with seat 21, thereby preventing fluid flow between ports 23, 43.

The second seal 90 is a floating seal assembly disposed within a seat 45 that is located at the upper end 47 of lower plate 40. Seal 90 moves vertically upward (or downward) in response to fluid pressure. The vertical movement of seal 90 is independent of that of seal 80 and closure disc 70.

Seal assembly 90 may be a ring 107 having two O-ring type seals 91, 97 that provide sealing engagement to prevent fluid flow between ports 23, 43. O-ring type seal 91 is disposed in an annular groove 93 located at the upper end 95 of ring 107. Seal 91 provides sealing engagement with the lower surface 77 of valve disc 70. O-ring type seal 97 is disposed in an annular groove 99 located about the peripheral surface 101 of ring 107. Seal 97 provides sealing engagement with an opposing wall surface 49 of seat 45.

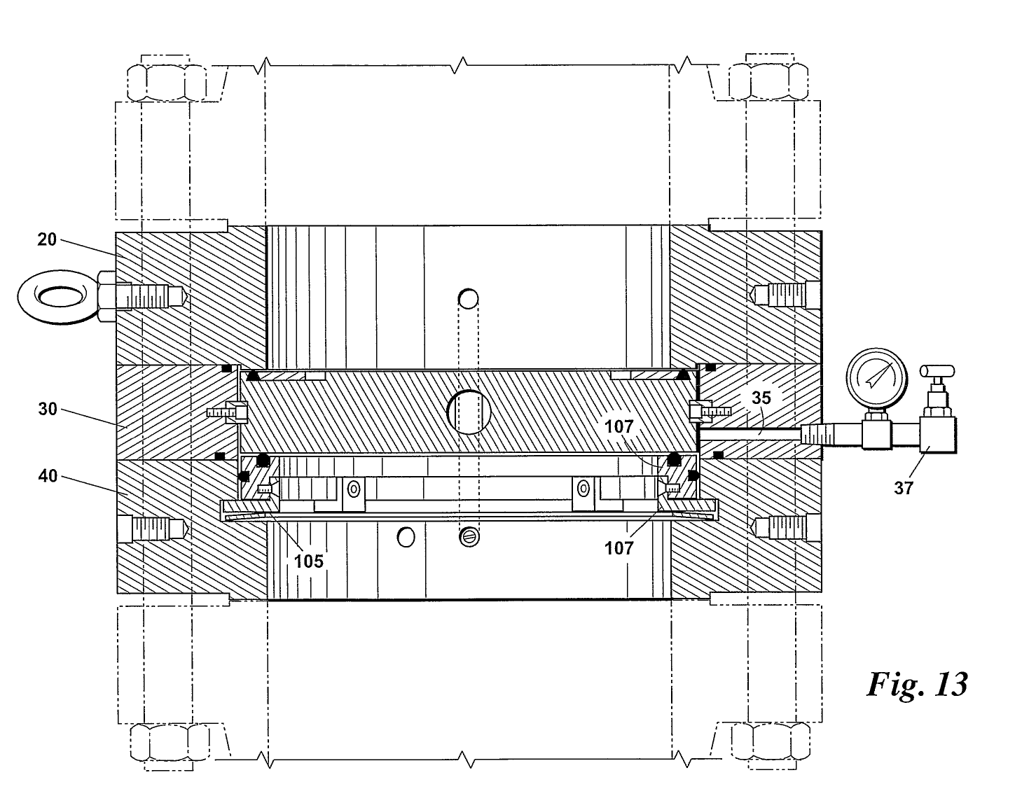

Seal 90 is preferably a light weight seal so that when fluid pressure below the seal begins to exceed 0 bars (that is pressure resulting in movement toward closure disc 70), the seal 90 is substantially instantaneously lifted up toward closure disc 70. Seat 45 may be any shape preferable and may be arranged to limit the vertical movement of seal 90 (see FIG. 13). For example, seat 45 may include a groove 51 that receives a plurality of L-shaped tabs 103 secured to the ring 107. Alternatively, ring 107 may be a segmented ring, each segment of the ring being L-shaped with the horizontal leg of the “L” being received by groove 51.

Additionally, a spring 105 may be added below ring 107 to keep seal 90 biased toward or urging against the lower surface 77 of valve disc 70 (see FIG. 13). Spring 105 may be a metal ring acting like a Belleville washer. Because seal 90 is lightweight and lifted by very low pressure, a foam- or gasket-type ring may also be used as spring 105. Alternatively, a plurality of L-shaped loaders (not shown) secured to the ring 107 at a few locations may serve as spring 105.

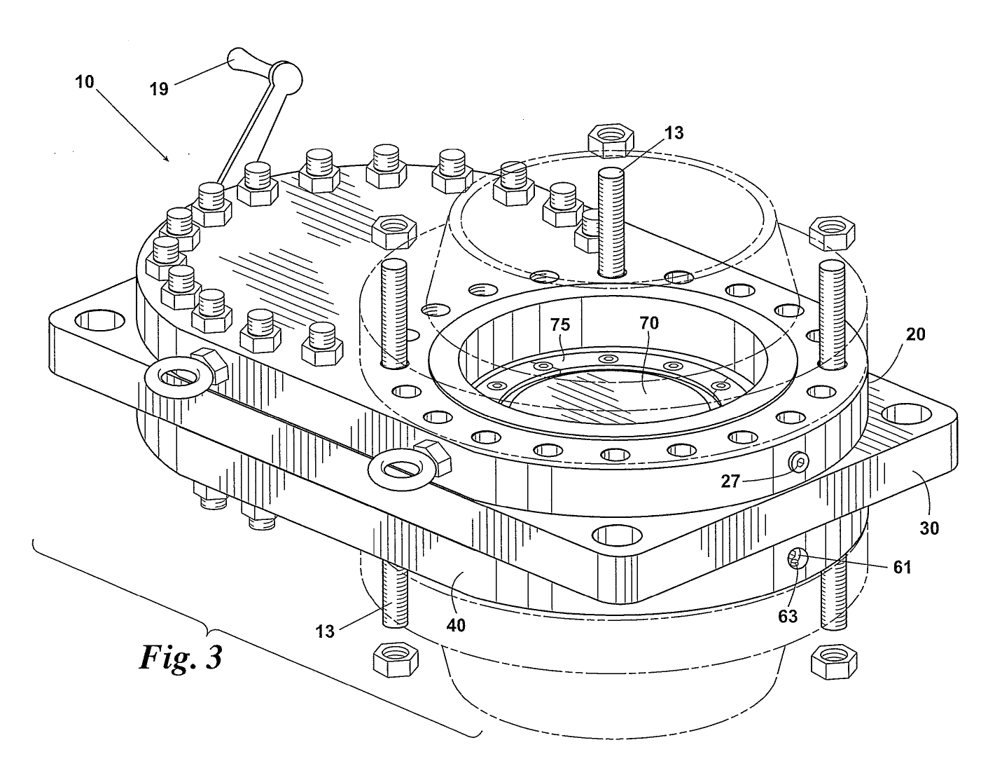

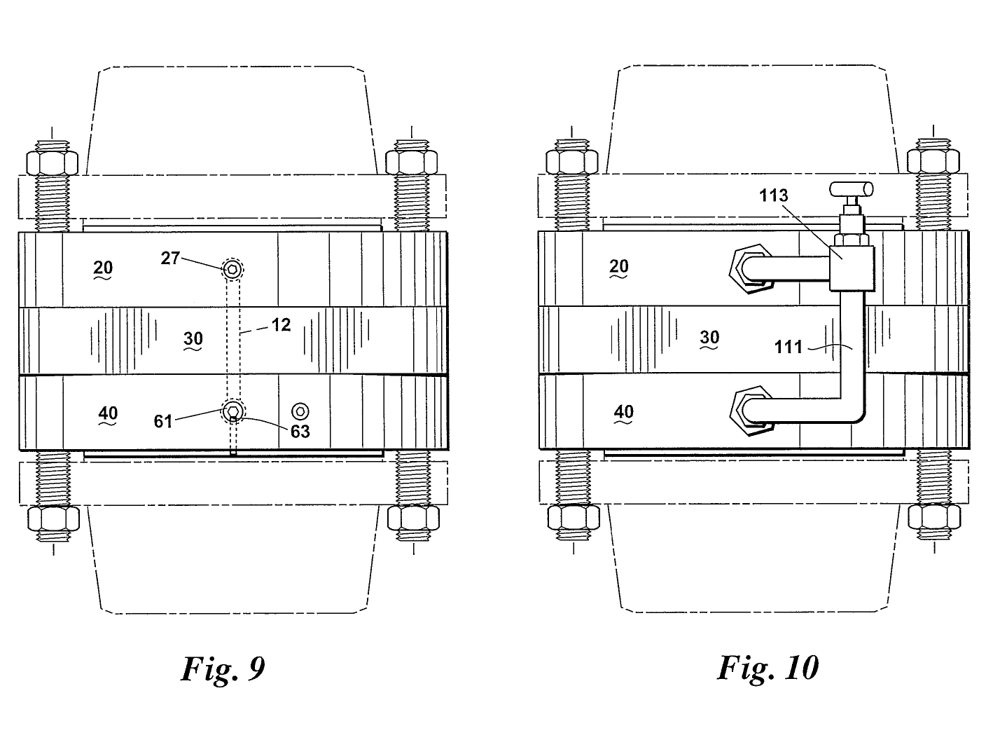

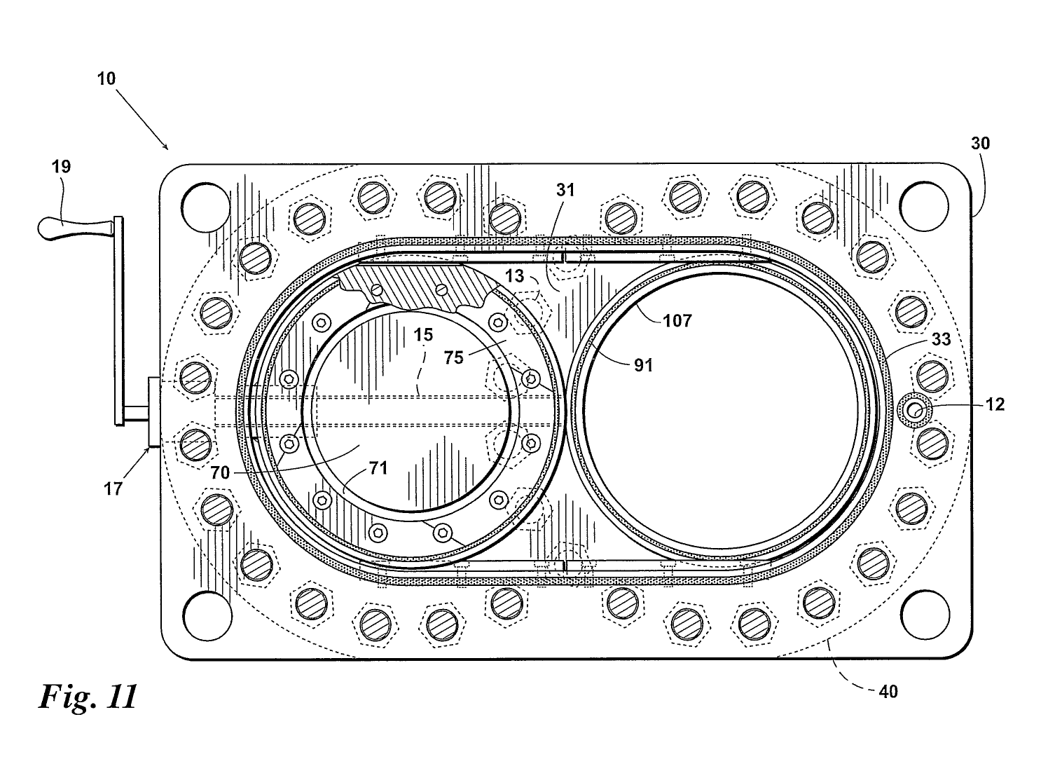

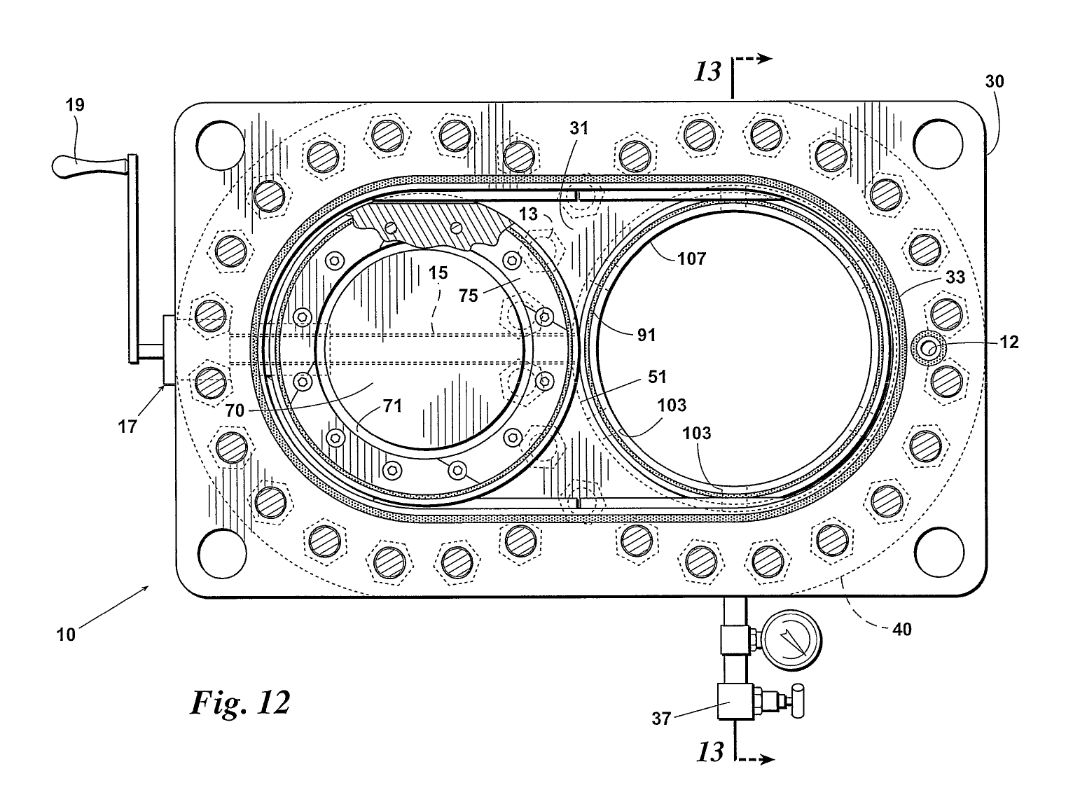

Sandwich-type valve 10 may be configured for internal bypass, external bypass, and preferably double block and bleed capability. Referring to FIG. 3, valve body 11 includes a bypass passageway 12. For internal bypass, the upper lateral portion 25 of passageway 12 receives a plug 27 and the lower lateral portion 59 of passageway 12 receives a threaded valve 61 (see FIG. 9). A pin 63 is preferably provided that prevents threaded valve 61 from backing out too far and venting to atmosphere. Bypass is prevented when threaded valve 61 is in the closed position (see FIG. 6) and permitted when the threaded valve 61 is in the open position (see FIG. 7). For external bypass, threaded valve 61 is removed and replaced with piping 65 and valve 67 (see FIG. 10). For double block and bleed capability, a passageway 35 may be provided in flange 30 between the seals 80, 90 and equipped with a bleed valve 37 in order to create a zone of isolation between the seals 80, 90 (see FIGS. 12 & 13). Passageway 35 and bleed valve 37 are preferably capable of handling whatever fluid (or gas) escapes past seal 90 to ensure that no unwanted buildup of pressure occurs across seal 80.

While an improved sandwich-type valve with double block and bleed capability has been described with a certain degree of particularity, many changes may be made in the details of construction and the arrangement of components without departing from the spirit and scope of this disclosure. A valve made and assembled according to this disclosure, therefore, is limited only by the scope of the attached claims, including the full range of equivalency to which each element thereof is entitled.

What is claimed is:

1. An improved sandwich-type valve in which a substantially flat valve disc located in a spacer flange blocks flow between ports located above and below the spacer flange in an upper and lower plate respectively, the valve disc being moveable in an open space of the spacer flange between a seated position across the ports to an unseated position laterally of the ports, the improvement comprising:
a first seal located on an upper surface of said valve disc; and
a second seal received by a seat of said lower plate;
said first seal being energized by a first fluid pressure and said second seal being energized by a second fluid pressure.

2. An improved sandwich-type valve according to claim 1 wherein in response to the first fluid pressure said first seal moves toward a lower surface of said upper plate and provides sealing engagement with said lower surface of said upper plate.

3. An improved sandwich-type valve according to claim 1 wherein in response to the second fluid pressure said second seal moves toward a lower surface of said valve disc and provides sealing engagement with said lower surface of said valve disc.

4. An improved sandwich-type valve according to claim 3 wherein said second seal provides sealing engagement with a surface of said lower plate.

5. An improved sandwich-type valve according to claim 1 wherein the first fluid pressure is a different pressure than the second fluid pressure.

6. An improved sandwich-type valve according to claim 1 further comprising a bleed port in said spacer flange, said bleed port being located between said first and second seals.

7. An improved sandwich-type valve according to claim 1 further comprising said second seal being an O-ring type seal.

8. An improved sandwich-type valve according to claim 1 further comprising said second seal including a first and second O-ring type seal, said first O-ring type seal being located on an upper surface of said second seal, said second O-ring type seal being located about a peripheral side surface of said second seal.

9. An improved sandwich-type valve according to claim 1 further comprising said lower plate and said second seal having means for limiting vertical movement of said second seal.

10. An improved sandwich-type valve according to claim 1 further comprising a spring, said spring biasing said second seal away from said lower plate.
